(19) United States
(12) Patent Application Publication
(10) Pub. No.: US 2017/0076367 A1
(43) Pub. Date: Mar. 16, 2017

(54) Systems, Methods, and Software For Lien Payoff and Transfer of Title

(71) Applicant: Dealertrack Inc., Lake Success, NY (US)

(72) Inventors: Timothy P. Sullivan, Sacramento, CA (US); Beverly J. DeVine, Las Vegas, NV (US); Adam Glover, Sacramento, CA (US); Erin B. Kuenneke, Waterford, CT (US)

(21) Appl. No.: 14/854,448

(22) Filed: Sep. 15, 2015

(51) Int. Cl. G06Q 40/02; G06Q 20/40; G06Q 20/02

(52) U.S. Cl. CPC G06Q 40/025; G06Q 20/027; G06Q 20/401

(57) ABSTRACT

Systems, methods, and software for loan payoff and title transfer that significantly streamline and simplify the process of effecting ownership transactions. Some embodiments may include a computer network for providing communication between a plurality of title requestors and a plurality of financial institutions. Exemplary systems may include loan payoff and title transfer servers that may be operably connected to one or more of a title manager, a plurality of lenders, and a plurality of users. Exemplary systems may be configured to provide instant and comprehensive information on a vehicle whose title is encumbered by a lien held by a lender. Exemplary systems may also be configured to execute an accelerated loan payoff and title transfer process.

### FIELD OF THE INVENTION

The present invention generally relates to the field of ownership transactions. More particularly, the present disclosure is directed to systems, methods and software for lien payoff and transfer of title.

### BACKGROUND

It is common for car dealerships to accept a used car from a purchaser as a “trade-in” for a portion of the purchase price for a new or used car the dealership is offering for sale. The dealership can then resell the trade-in at retail, wholesale, or auction. It is also common for the purchaser to still owe money on a trade-in to a lender that financed the purchase of the trade-in. In those circumstances, the car dealership must work with the lender to pay off any outstanding loan balance and obtain the title for the trade-in before the dealership can resell the trade-in. Insurance companies similarly need to pay off outstanding loan balances to obtain title when an insured vehicle with an outstanding loan balance is totaled. Automotive auction houses also need to arrange for paying any outstanding balance in order to obtain clear title on vehicles the auction house has purchased for resale.

In the case of a car dealership or auction house, each day the dealership or auction house is forced to keep the trade-in in inventory while it is waiting for the loan to be satisfied and the title to be delivered represents lost profits. Insurance companies similarly minimize costs by transferring a totaled vehicle as soon as possible. Thus, it is in the title requestor's (e.g., dealership's, auction house's, insurance company's) best interest to pay off the outstanding balance and obtain title as quickly as possible. Current systems and methods for loan payoff and title transfer, however, are cumbersome and inefficient, with much of the process between the title requestor and lenders still occurring over the phone. Existing efforts to automate the process using computers and electronic communications have also been inadequate, with most attempts simply replacing phone communication between the title requestor and lender with electronic communications. While existing electronic loan payoff and title transfer systems may reduce the amount of time title requestor personnel must spend on the phone, current electronic systems have not had a significant impact on reducing the overall time for completing a loan payoff and title transfer process. In addition, current processes are also susceptible to fraud, where it is difficult for dealerships to uncover a purchaser's fraudulent statements relating to an existing trade-in loan or a purchaser's late or missed payments on a trade-in loan until late in the car-buying process or not until after the dealership has completed the transaction with the customer. Also, current processes often result in the initial payoff amount received by a lender being inaccurate, potentially resulting in additional delays, and when the payment is too high, overpayment by the consumer.

### SUMMARY OF THE DISCLOSURE

In one embodiment, the present disclosure is directed to a computer-implemented method for paying off a loan secured by a lien on a vehicle and transferring the vehicle's title to a title requestor. The computer-implemented method includes receiving, at a loan payoff and title transfer server, a payoff quote request including lender and loan identification information; accessing, with the loan payoff and title transfer server, loan and title information; calculating, with the loan payoff and title transfer server, based on the loan information, an exact payoff amount for paying off the loan; displaying, on a quote user interface (UI), the title information and the exact payoff amount; receiving, via the quote UI, a user instruction to pay off the loan; initiating, with the loan payoff and title transfer server, an electronic fund transfer of the exact payoff amount from a title requestor bank account to an intermediate bank account; transferring, with the loan payoff and title transfer server, the exact payoff amount from the intermediate bank account to a lien-holder bank account; and sending, with the loan payoff server, a title transfer instruction to a title manager to send the title to the title requestor.

In another embodiment, the present disclosure is directed to a title transfer portal for providing automated payoff of loans secured by liens on vehicle titles held by a plurality of lenders. The title transfer portal includes at least one loan payoff and title transfer server having a memory containing machine-executable instructions for providing: a request quote user interface (UI) designed and configured to solicit and receive from a user lender information and loan information associated with a vehicle having a title; and a payoff quote user interface designed and configured to display to the user, substantially immediately after receiving the lender and loan information: a title status indicating whether or not the title is releasable; an image of the title; an exact payoff amount calculated by the at least one loan payoff and title transfer server based on a predetermined electronic fund transfer process; and a payoff button selectable by the user to initiate a fund transfer for the payoff amount using the predetermined electronic fund transfer process.

In yet another embodiment, the present disclosure is directed to a loan payoff and title transfer system. The loan payoff and title transfer system includes a title manager including a title vault and at least one title manager server, said title vault containing a plurality of vehicle titles of vehicles encumbered by liens held by a plurality of lenders; and at least one loan payoff and title transfer server operably connected to said at least one title manager server, said at least one loan payoff and title transfer having or operably connected to a memory containing machine-executable instructions for: receiving a payoff quote request from a title requestor for a loan held by one of the plurality of lenders that is secured by a lien on a vehicle associated with one of said plurality of vehicle titles stored in said title vault, the payoff request including lender and loan identification information; accessing loan information associated with the loan; requesting, from said title manager server, title information associated with the vehicle title encumbered by the lien; calculating, based on the loan information, an exact payoff amount for paying off the loan; and displaying, on a quote user interface (UI), the title information and the exact payoff amount.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 shows an exemplary loan payoff and title transfer system for paying off a loan secured by a lien on a vehicle and transferring the title to a title requestor;

FIG. 2 is a conceptual diagram of exemplary software for use with the system of FIG. 1;

FIG. 3 shows an example algorithm for a loan payoff and title transfer system;

FIG. 4 shows an example algorithm for a payoff calculation software module;

FIG. 5 shows an exemplary request quote user interface (UI);

FIG. 6 shows an exemplary account verification UI;

FIG. 7 shows an exemplary quote UI;

FIG. 8 shows another example of the exemplary quote UI of FIG. 7;

FIG. 9 shows an exemplary requested quotes UI;

FIG. 10 shows an exemplary submitted quotes UI; and

FIG. 11 is a block diagram of a computing system that can be used to implement one or more aspects of the present disclosure.

### DETAILED DESCRIPTION

Aspects of the present disclosure include systems and methods for the payoff of an outstanding balance on a loan associated with a vehicle that is secured by a lien on the vehicle, and for the transfer of the vehicle's title to the purchaser. Some examples may include a computer network for providing communication between a plurality of title requestors, such as a plurality of one or more of car dealerships, insurance companies, or auction houses, and a plurality of financial institutions. Aspects may also include computer systems configured with one or more user interfaces (UIs) for displaying information associated with a vehicle that a dealership may need for negotiating a new deal involving a trade-in and for initiating payment for any outstanding balance on an existing loan for the trade-in and for transferring title to the dealership. In some embodiments, in response to a user input of loan and customer information, a title transfer system may be configured to substantially instantly display an image of the vehicle title and title status information and may also be configured to display an exact payoff amount associated with an outstanding loan. Exemplary systems may also be configured to receive an instruction from a user to initiate payment from the user to the lender and initiate the transfer of the physical title associated with a vehicle from a title holder to the user. Exemplary systems may also provide up-to-date status information on a loan payment and title transfer, eliminating the need to call a lender or title holder to check status. Exemplary systems may also provide an integrated platform for loan payoff and title transfer, and real-time status of a plurality of transactions involving a plurality of lenders and vehicle titles. Such systems may also create consistency in the loan payoff process across a plurality of lenders and may also provide a large-scale financial transaction gateway between a plurality of title requestors and a plurality of lenders. As will be appreciated, in cases where exemplary embodiments are described in connection with a specific type of title requestor, such as a car dealership, the same or similar systems, methods, and software may be used for any other type of title requestor that desires to pay off an existing loan balance and obtain a physical or electronic title, including, for example, insurance companies and auction houses.

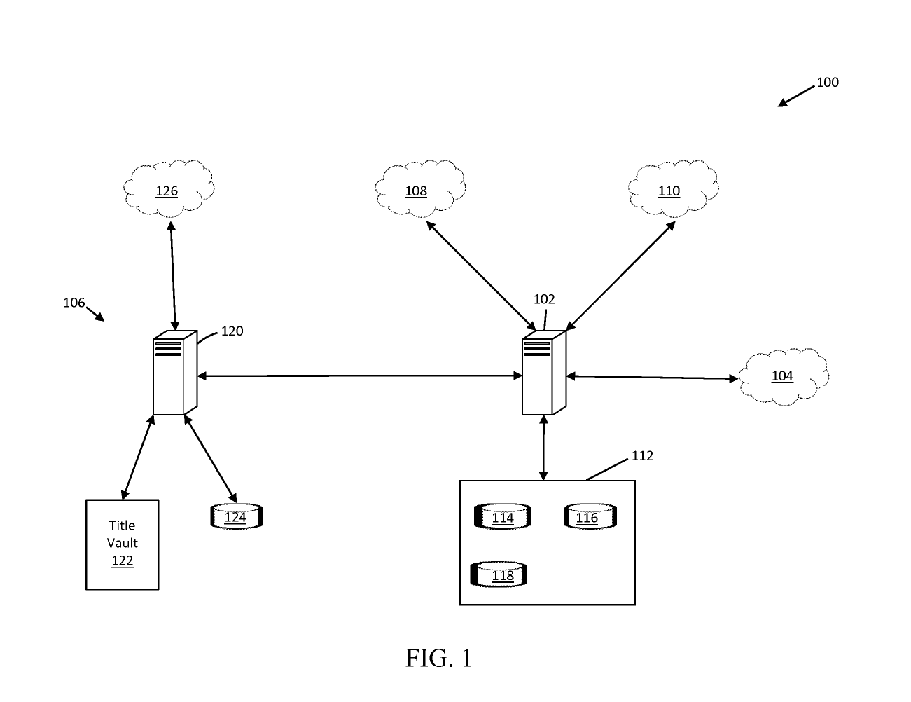

FIG. 1 illustrates exemplary loan payoff and title transfer system 100 for implementing aspects of the present disclosure. As shown, exemplary system 100 may include a computer network having one or more loan payoff and title transfer servers 102 configured to communicate with a plurality of title requestors 104, e.g., car dealerships, insurance companies, auction houses, or other title requestors, and provide an integrated loan payoff and title transfer portal for providing automated payoff of loans secured by liens on vehicle titles held by a plurality of lenders 110. In some embodiments, system 100 may be configured to provide title requestors 104 with one or more of vehicle loan payoff and title information, to process fund transfers for loan payoff, and to process title transfers from a title manager 106. Server 102 may also be connected to a fund transfer service 108 for processing electronic fund transfers, one or more lenders 110 for receiving lender and loan information and for transmitting electronic payments, and databases 112 for accessing and storing information. In the illustrated example, databases 112 may include a lender database 114 for storing information associated with participating lenders and information on associated vehicles and loans, a user database 116 for storing information associated with title requestors 104, and a title transfer database 118 for storing information associated with title transfer requests, including previous payoff quotes and real-time status of payoff and title transfer requests.

Exemplary title manager 106 may include one or more servers 120 operably connected to one or more physical title vaults 122 that store physical vehicle titles and one or more title database(s) 124 for storing information associated with titles being managed by the title manager, such as one or more of vehicle and owner identification information, number of liens on the title, real-time title status, and images of the physical titles. In one example, title status may include whether or not a title is available for transfer. For example, a vehicle title may not be “releasable” when it is “out for maintenance” indicating a Department of Motor Vehicles (DMV) is changing or updating something on the title and that it is, therefore, not currently available for transfer. Title manager server 120 may also be operably connected to various state Electronic Lien and Title (ELT) systems 126 for, e.g., obtaining title status information for electronic titles being held by a state ELT system and for sending title transfer instructions for instructing a state ELT system to transfer an electronic title to a designated recipient. As will be appreciated by a person having ordinary skill in the art, the components of system 100 may be configured using any of a variety of computer network architectures and may use any of a variety of software architectures and information exchange protocols for communicating information across the network. In one example, server 102 may include one or more servers running a Java-based enterprise application platform such as, e.g., a jBoss™ platform, and may communicate with title manager 106 and databases 112 using one or more Representational State Transfer (REST) software architectures, and may communicate with fund transfer service 108 using Simple Object Access Protocol (SOAP). In alternative embodiments, any of a variety of other architectures may be implemented.

By providing an integrated platform such as system 100, the system may provide a portal through which users may have immediate access to title, lien, and owner information associated with millions of vehicles, any one of which being a potential trade-in, in a way that has never been accomplished before, which may be helpful during an initial negotiation process with a potential purchaser. For example, a dealer may log onto system 100 and enter vehicle identification information, e.g. a vehicle identification number (VIN), make, model, etc., for a potential trade-in, and server 102 may communicate with title manager 106 to immediately display a current status of the title associated with the vehicle as well as an image of the vehicle's title, which may be accessed from title database 124. A dealer may also be able to immediately obtain a current payoff amount on any outstanding loan associated with the trade-in, which, as described more below, may be an exact payoff amount calculated by server 102 based on information stored in, e.g., lender database 114 or directly accessed from lender 110. Thus, a dealer may immediately obtain all relevant information on existing liens and loans associated with a trade-in, the current status of the trade-in's title, and verify the person purporting to be the owner of the trade-in is in fact the true owner. Further, a dealership can obtain the information at the beginning of a negotiation process with a purchaser and substantially immediately after submitting the request for information. This is in contrast to current systems and methods that often require a dealership to contact one or more of a lender, title manager, and DMV, and potentially wait hours or days to obtain all of the information.

The availability of such instant and comprehensive information can be invaluable to title requestors. For example, in the case of car dealerships, it can help avoid wasted effort spent on negotiating a new deal with a purchaser and obtaining funding for the new deal, etc., based on incorrect information, such as, e.g., assuming the purchaser is the owner of the trade-in when he or she is not. In some embodiments, such as when title requestor 104 is a dealership, the dealership can immediately view an image of the vehicle title and confirm ownership. Another problem that may arise is a dealership may assume the purchaser is the borrower on the loan when he or she is not. In some embodiments, title requestor 104 using system 100 can view loan information accessed from lender database 114 or directly from lender 110 by server 102 to confirm loan information including borrower information. Another problem that may arise is assuming the vehicle title is subject to only one lien held by a lender when it is actually subject to multiple liens. In some embodiments, a title requestor 104 using system 100 can confirm the number of liens by accessing information from title database 124. Another problem that may arise is assuming a trade-in vehicle's title is releasable when it is not. In some embodiments, a title requestor 104 can instantly confirm the title is releasable by accessing information from title database 124.

As described more below, system 100 may also be configured to facilitate the entire process of transferring funds to a lender to satisfy an existing loan and transferring a vehicle title to a title requestor, which can significantly accelerate the process and reduce errors and delays that currently occur with existing payoff and title transfer processes. For example, server 102 may be configured to receive an instruction from one of title requestors 104 to initiate payment to one of lenders 110 to pay off an existing loan. Server 102 may communicate with fund transfer service 108 to initiate an electronic fund transfer for the payoff amount from a bank account of title requestor 104. In one example, server 102 may instruct fund transfer service 108 to transfer the payoff amount to an intermediate account (not shown) associated with system 100 instead of directly to a lender 110 bank account. In another example, fund transfer service 108 may transfer funds directly from a user account to a lender account. In one example, server 102 may wait until the payoff amount has been received and verify the payoff amount is available or cleared, for example, pursuant to any rule specific to a given fund transfer method, and confirm the payoff amount is accurate, and system 100 may then transfer the payoff amount, in addition to any other payoff amounts ready for transfer, to lenders 110.

Server 102 may also send a title release instruction to title manager 106 before, substantially at the same time as, or immediately after the payoff amount has been transferred to lender 110, and in some embodiments, the title release may be sent without waiting for lender review or approval. Thus, in one embodiment, server 102 may be configured to initiate the transfer of the vehicle title at substantially the same time the payoff funds are transmitted to lender 110. Such a system and method may result in a significant reduction in the amount of time between title requestor 104 initiating a payoff process and receiving title. For example, while it is common with current systems and methods for a title requestor such as a dealer to have to wait several weeks to a month to receive a physical title, systems and methods disclosed herein may result in a title requestor receiving physical title in less than one week, e.g., four days. In another embodiment, system 100 may be configured to transfer title to a title requestor 104 in a number of days equal to a required waiting period associated with a predetermined electronic payment process plus a number of days required for mailing a physical title to a title requestor. In addition, as described more fully below, embodiments of the present disclosure may substantially eliminate under and over payment, providing lender 110 with the exact payoff amount. Such an integrated approach significantly reduces title requestor and lender employee time spent throughout the process and eliminates time currently spent on fixing problems that may arise in a title transfer process, such as any of the common problems discussed herein.

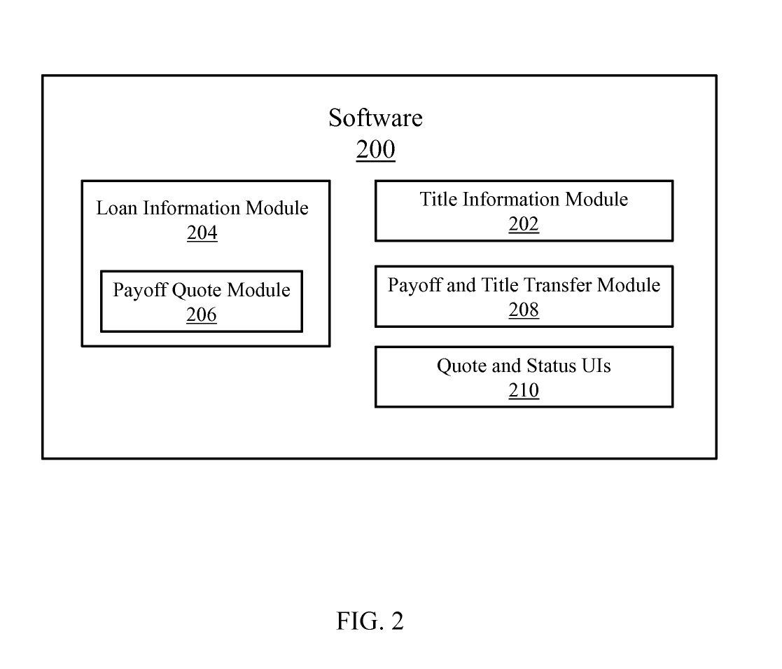

Referring to FIG. 2 and also to FIG. 1, FIG. 2 illustrates exemplary software 200 that may be stored in computer readable media, such as machine-readable storage media, operably connected to server 102 and that server 102 may be configured to execute. As shown, software 200 includes a title information module 202 that may include instructions for causing server 102 to obtain all relevant title information associated with a trade-in, including whether the title is releasable and an image of the title. In one embodiment, title information module 202 may receive trade-in identification information that may be transmitted to title manager 106 with instructions for the title manager to return title status information and, in some embodiments, an image of the title or otherwise provide access to the image. In one example, the trade-in identification information transmitted to title manager 106 may include one or more of a vehicle identification number (VIN), vehicle description information, e.g., make, model, year, etc., lender identification information, and owner information. The title status information that may be returned by title manager 106 may include one or more of, whether the title is currently releasable, or is instead not available, e.g., out for maintenance, the title format, e.g., whether the title associated with the vehicle is a physical paper title or electronic, the current geographic location of the title, e.g., the location of title vault 122 where the title is located, the number of liens encumbering the title, the name(s) of the entity(ies) holding the liens, and the name(s) of the owner(s) listed on the title. By transmitting an image of the title, a title requestor 104 can instantly confirm vehicle ownership and lien information. In some embodiments, title manager 106 may only return title releasability, number of liens, and an image of the title.

Software 200 may also include a loan information module 204 that may include instructions for causing server 102 to provide, e.g., via an electronic display, all relevant loan information associated with a trade-in, such as lender name and contact information and the name of the borrower(s) associated with the loan, and may also include a payoff quote module 206 configured to calculate a payoff amount. In one embodiment, loan information module 204 may be configured to receive lender information and customer information for transmitting to one of lenders 110 for obtaining loan information. For example, loan information module 204 may receive a user selection of a particular lender from the plurality of lenders 110 and may also receive vehicle and/or customer identification information such as VIN, customer name, loan account number, etc. In one embodiment, server 102 may have connectivity with one or more of the plurality of lenders 110 and may access the system of the particular lender identified by the user, such as the lender's loan origination system or loan servicing system, and server may use the customer information provided by the user to obtain all relevant loan information associated with the trade-in. In another embodiment, one or more of lenders 110 may regularly transmit updated loan information to server 102 for storage in lender database 114, and server 102 may use the lender and customer information provided by the user to access the relevant loan information from the lender database. Loan information obtained from lender 110 may include one or more of a loan account number, principle balance, interest rate, per diem value (daily dollar amount of interest), term of the loan, months left on the loan, the next scheduled payment date, the borrower's monthly payment, any unpaid fees, borrower and co-borrower name(s) and addresses, vehicle VIN, make, and model, etc.

In one embodiment, payoff quote module 206 may be configured to use the loan information received from lender 110 to calculate an exact payoff amount for paying off a loan associated with a trade-in that avoids any possible under or over payment. For example, prior art methods of calculating a payoff amount may include an assumed number of days' interest that will accrue, e.g. ten days, between the day the payoff estimate is generated and the day the payoff is received, or a payoff estimate may not include any days' interest. A title requestor interested in paying off a loan must then independently determine exactly how long it will take for its payment to be received by a lender to determine an exact payoff amount, which oftentimes does not occur, resulting in the lender receiving either an over or under payment. By contrast, payoff quote module 206 may be configured to calculate an exact payoff amount based on the number of days required for a predetermined electronic funds transfer process utilized by system 100 to complete a funds transfer. Payoff quote module 206 may also use calendar information including the date the quote is generated and take into account weekends and holidays to determine the exact timing and amount. In one embodiment, system 100 may utilize the Automated Clearing House (ACH) network for executing fund transfers and payoff quote module 206 may be configured to account for time periods required for funds to clear via an ACH process, such as the time periods required by National Automated Clearing House Association (NACHA) regulations, to determine an exact payoff amount. Thus, an exact period of time required to complete the transfer can be determined based on the calendar day the payoff quote is generated and a predetermined electronic funds transfer process, e.g., ACH. In other embodiments, other electronic fund transfer processes may be used. In yet other embodiments made in accordance with the present disclosure a system may not generate an exact payoff amount and may instead generate a principle-only payoff amount or a payoff amount with an assumed number of per diem days that is not tied to a specific funds transfer process.

Software 200 may also include a payoff and title transfer module 208 for executing a fund transfer for paying off a loan and for transmitting a vehicle title to a title requestor. In one embodiment, payoff and title transfer module 208 may be configured to receive a payoff instruction from a user and may send payoff instructions to fund transfer service 108 for initiating the fund transfer process. In one embodiment, payoff and title transfer module may instruct fund transfer service 108 to withdraw the payoff amount from a specified account owned by a title requestor 104. In one embodiment, the payoff amount may be transmitted to an account associated with system 100, and after the funds have cleared, server 102 may transfer the payoff funds to a lender account. When, e.g., the funds clear, payoff and title transfer module 208 may also instruct title manager 106 to initiate the transfer of the trade-in title to the title requestor.

Software 200 may also include one or more quote and status UIs 210 for, e.g., providing UIs for receiving user selections, displaying loan and title information, and displaying quote status information for displaying a real-time status of payoff requests and title transfers. For example, server 102 may store status information in title transfer database 118, including the status of a payoff fund transfer and status of a title transfer, and the status information may be accessed and displayed by one of UIs 210. It is noted that while the term “module” is used herein, this term is not intended to require any particular configuration of the corresponding software code. For example, “module” should not be construed to mean that the software code is embodied in a discrete set of code independent of the software code for software 200. Rather, the term “module” is used herein merely as a convenient way to refer to the underlying functionality.

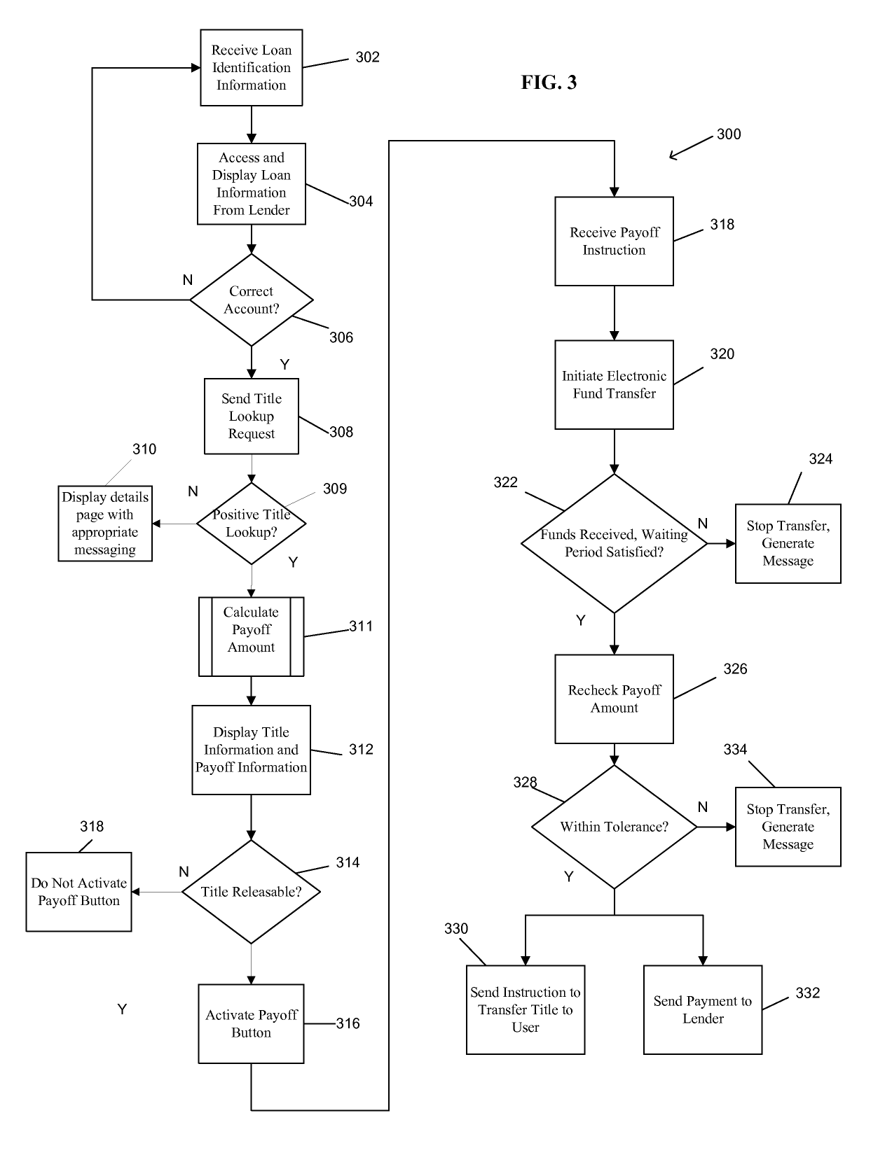

Referring now to FIG. 3, and also to FIGS. 1 and 2, FIG. 3 illustrates an exemplary method 300 that server 102 (FIG. 1), running software 200 (FIG. 2), may be configured to execute. As shown in FIG. 3, at step 302, server 102 may be configured to receive loan identification information for identifying the loan associated with a potential trade-in. As described above, loan identification information may include identification of one of lenders 110 (FIG. 1), customer information, and vehicle information. At step 304, method 300 may include using the loan identification information to access all relevant loan information by, e.g., accessing loan information directly from a system of a lender 110 or by accessing the information from lender database 114. In the illustrated embodiment, at step 306 server 102 may cause to be displayed to a user, e.g., a title requestor 104, at least some of the loan information it has accessed from lender 110 so that the user can compare the displayed loan information with the information the user has received from a potential purchaser. In some cases, multiple records may be returned associated with multiple loans from one or more lenders that at least partially matches the loan identification information provided by the user. Server 102 may receive a user selection to confirm whether system 100 has identified the correct loan. In the case of a single returned record, a user may simply confirm whether the single record is correct and in the case of multiple records, server 102 can display a UI for the user to select the appropriate record. If the user indicates the correct record has not been found, the process can return to step 302 so that the user may re-submit the request. If system 100 has identified the correct loan from the lender information, at step 308 server 102 may access title information from title manager 106 and the title manager may return any of the title status and information described above, including title releasability, lien information, and an image of the title. In one embodiment, server 102 may transmit certain pieces of the loan information obtained from lender 110 that was confirmed as accurate by the user at step 306 to title manager 106 to verify the information being obtained from title manager 106 and lender 110 relate to same vehicle and lien. Such verification can be important for ensuring the integrity and accuracy of system 100. For example, system 100 is configured to integrate what has previously been disparate systems—title management solutions, online payoff quote services, and lender systems to provide an integrated system for accurate and rapid lien payoff and title transfer. In the illustrated example, such integration is enabled by verifying the information being obtained from lender 110 and title manager 106 relate to the same vehicle and lien. Thus, at step 308, server 102 may send a title lookup request to title manager 106 with information obtained from lender 110. At step 309, server 102 verifies whether there was a positive title lookup. In the illustrated example, a positive lookup will only occur when the information required by title manager 106, exactly matches the information obtained from lender 110. If there is not an exact match, at step 310 the process may terminate and server 102 may display a details page with appropriate messaging that explains the accelerated lien payoff process cannot continue and that the user must use an alternative approach to obtain title. If, however, there is a positive match, at subroutine 311 server may proceed with calculating an exact payoff quote. In some embodiments, to ensure the integrity of the lender and title manager systems throughout the process, server 102 may also obtain a unique title ID provided by title manager 106, which may be stored with the specific payoff and title transfer transaction for future validations (described more below). Storing the unique title ID can help ensure the same title information is used through the life cycle of each transaction, including at the time a user decides to actually payoff an existing loan (step 318) and the unique title ID may also be used just prior to initiating the transfer of funds from system 100 to lender 110 (steps 326, 328, 330, 332), which ensures the title is still available, since in the illustrated example, days will have passed since the first user inquiry that began at step 302.

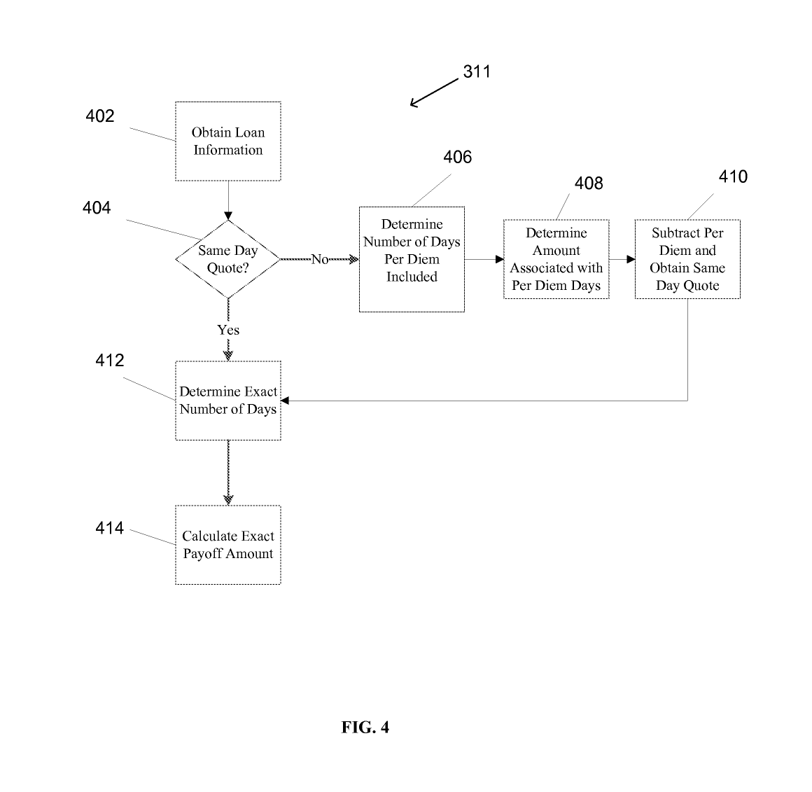

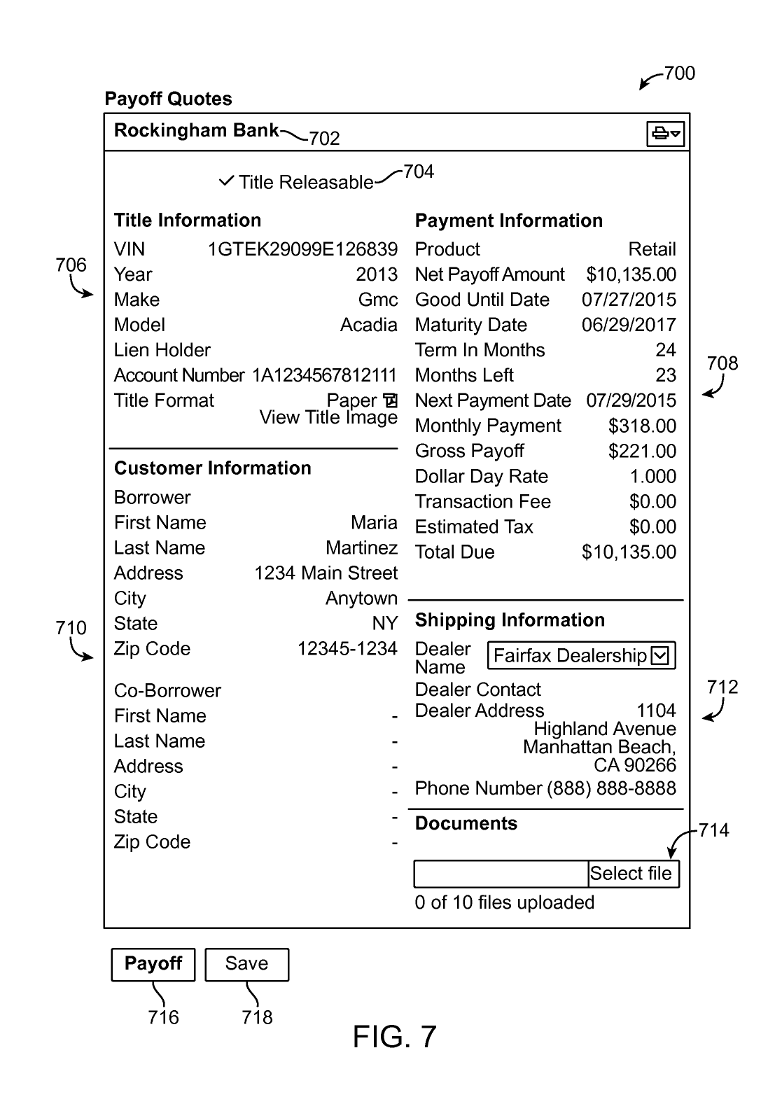

At subroutine 311, server 102 may calculate an exact payoff amount using, for example, the process shown in FIG. 4 and the techniques described above, including using loan information obtained from a lender, such as, e.g., payoff amount, daily dollar rate, interest rate, last payment date, next payment date, etc., and information associated with a fund transfer process, such as, e.g, the ACH process, to determine an exact payoff amount. At step 312, server 102 may display the title and payoff information to the user and at step 314, the program may check whether the title is releasable and if so, at step 316 may also display a payoff button (see, e.g., payoff button 716 of FIG. 7) that a user may select to initiate the payoff and title transfer process and if not, at step 318, the payoff button may not be displayed or otherwise activated and a user may not be able to proceed further. In some embodiments, at step 314, server 102 may also check the permissions associated with the particular user's account and only activate the payoff button if the user's account has the appropriate permissions for initiating the payoff of an outstanding loan. In addition to releasability, software 200 (FIG. 2) may also not activate the payoff button if other conditions are not met, for example, if the title is subject to more than one lien, or if the borrower and owner information are not consistent.

In some embodiments, a user may exit software 200 (FIG. 2) at step 316 or 318 and use the title information and payoff information for, e.g., negotiating a new deal with a potential purchaser. If the user wishes to continue and software 200 has activated the payoff button, e.g., when a dealer has finalized a deal and any additional financing for the new deal has been obtained, at step 318, a user may instruct server 102 to initiate payoff of the outstanding loan, e.g., by selecting the payoff button. Upon receipt of a payoff instruction, at step 320, server 102 may initiate an electronic funds transfer in the amount of the payoff value determined during subroutine 311. As described above, server 102 may send an instruction to fund transfer service 108 to initiate the funds transfer and to transmit the funds to an account associated with system 100. At step 322, server 102 may check to confirm the funds have been received and any waiting period for confirming the funds have cleared has passed. If the funds did not clear, e.g., if a Not Sufficient Funds (NSF) message is received from a title requestor's bank indicating the title requestor's account did not have sufficient funds, at step 324, server 102 may stop the transfer process and generate a message to the user indicating the problem(s) encountered in the fund transfer process. In some embodiments, a required waiting period may vary by lender and by title requestor. For example, lender database may include information on required waiting times. In some cases, a lender may allow system 100 to initiate a title transfer instruction at the same time as the electronic fund transfer is initiated, i.e., no waiting period, for trusted title requestors.

If the funds clear, then at step 326, server 102 may recheck the payoff amount, for example, by confirming the amount owed has not changed since the payoff was previously calculated when the payoff process was initiated. The server 102 may verify the payoff by obtaining current loan information directly from a lender's loan origination or loan servicing system, or by accessing the information from lender database 114. In one example, the payoff amount may be verified by obtaining current loan information from a lender, back-calculating a principle balance, and then re-calculating an exact payoff amount from the same date the original payoff amount was calculated when the payoff instruction was received. The re-calculated value may then be compared to the original value which may be stored from the previous calculation. Alternatively, the principle balance may be separately stored and the system may compare the current principle balance with the previous principle balance to confirm it is the same.

The payoff amount may be rechecked at step 326 because during the period of time since the previous payoff calculation, the principle amount of the loan may have changed. For example, a user may have canceled a pending payment after negotiating with a dealer, resulting in a higher payoff amount, or a user's loan payment may have been processed, resulting in a lower payoff amount, or additional fees may have been added to the principle due to, for example, a late payment. Thus, server 102 may be configured to validate the amount being transferred to the lender is the appropriate amount at least three distinct times during the payoff process, including a first time at step 316 when a user first requests payoff information for a loan, a second time when the user decides to initiate the payoff process at step 318, and a third time at step 326 after funds have been received by an account associated with system 100 and any required waiting period has been satisfied.

At step 328, server 102 may compare the current payoff amount determined at step 326 with the amount of funds pending transfer and/or the previously calculated payoff amount, and if the difference, if any, is within a predefined tolerance, the server may proceed with the payoff and title transfer process. At step 330, server 102 may send an instruction to title manager 106 to release the title and transfer the title to the title requestor. For example, title manager 106 may receive the title release instruction and may begin an expedited title release process for removing the title from title vault 122 and mailing the physical title to a user-specified mailing address obtained, e.g., from user database 116. In the case of electronic titles held by a DMV, server 102 may send a title release instruction to the appropriate DMV holding the electronic title. Title manager 106 may also continuously send status updates to server 102 for storage in title transfer database 118 at each stage of the title transfer process. In the illustrated embodiment, server 102 may execute step 332, transmitting the payoff funds from the system 100 account to a lender account, substantially simultaneously or in close succession with step 330. In one embodiment, server 102 may be configured to process daily batch fund transfers to ones of lenders 110 on the same day funds for specific payoff and title transfer requests have cleared.

Returning to step 328, if the current payoff amount is not within the predefined tolerance of the earlier payoff amount, at step 334, server 102 may stop the funds transfer process and not initiate the title transfer process and may generate a message to the user detailing the change in the payoff amount. In one embodiment, the predefined tolerance may be obtained from lender database 114 and may be a value selected by a lender. For example, some lenders may not approve of title manager 106 sending a title to a title requestor if there is any difference (i.e., a tolerance of zero) while other lenders may provide a tolerance that allows the current payoff amount to be equal to or less than the amount being transferred from a title requestor but not more than the amount, and yet other lenders may provide other tolerance values, such as a specific +/− dollar amount that is acceptable. Thus, the illustrated method significantly reduces the amount of time lenders previously needed to address inaccurate payoff amounts. The illustrated method returns payment to a title requestor at step 332 and only allows acceptable payoff amounts to be transferred to a lender.

FIG. 4 an illustrates exemplary payoff quote calculation subroutine 311 (FIG. 3) that may be implemented, e.g., by payoff quote software module 206 (FIG. 2). As shown in FIG. 4, exemplary payoff calculation subroutine 311 may include, at step 402, obtaining loan information from lender 110, such as, e.g., payoff amount, daily dollar rate, interest rate, last payment date, next payment date, etc. At step 404, server 102 may determine whether the information received at step 402 is a same day quote. For example, as is known in the art, many online payoff quote calculators and services currently exist, where lenders may provide payoff information. However, the format of the information provided by the lenders can vary. Some lenders provide a same day quote, which would be the amount required to payoff the loan that day. Other lenders include some assumed number of days' interest in the calculated quote. Such inconsistency has been acceptable for prior art payoff quote systems because they only provide an estimated payoff quote for information purposes. Illustrated system 100, however, is configured to automatically initiate and process loan payoffs from any one of a variety of disparate lenders and is, therefore, configured to determine an exact payoff amount for initiating an electronic funds transfer process which, in the illustrated example, includes determining a same day quote and then adding a precise amount of interested based on a known funds transfer process.

Thus, server 102 may be configured to determine whether the information received is a same day quote based on information received at step 402, or by accessing information on a specific lender's loan information data format from, e.g., lender database 114. If the information is not a same day quote, at step 406, server 102 may determine the number of days' interest (per diem days) included in the payoff number provided by the lender. At step 408, server 102 may determine the amount the lender has added to the payoff quote by, e.g., calculating the amount associated with the number of days and, at step 410 the server can subtract the per diem amount to remove the added interest and obtain a same day quote.

At step 412, process 400 may also include receiving all relevant information associated with a predetermined electronic funds transfer method for determining the exact amount of time required to complete the fund transfer in order to determine the exact number of days' worth of interest/per diem to add to the principal. In one example, the fund transfer process may be an ACH process and durations associated with executing a ACH transfer may be obtained. In the illustrated example, such determining may be based on the time of day (for example, if the calculation is performed after a predetermined cut off time, an additional day may be added), day of the week, and may account for weekends and holidays, to ensure an exact payoff at the end of a predefined funds transfer process period. At step 414, an exact payoff amount may be calculated by determining a precise amount of interest, which can be calculated based on the loan information obtained at step 402 and the exact number of days determined at step 412. The precise amount of interest can then be added to either a same day quote provided by a lender 110, or a back-calculated same day quote determined by server 102 at step 410. As described above, the exact payoff quote may be used by system 100 to transfer the exact amount required to satisfy a loan thereby avoiding under and over payment.

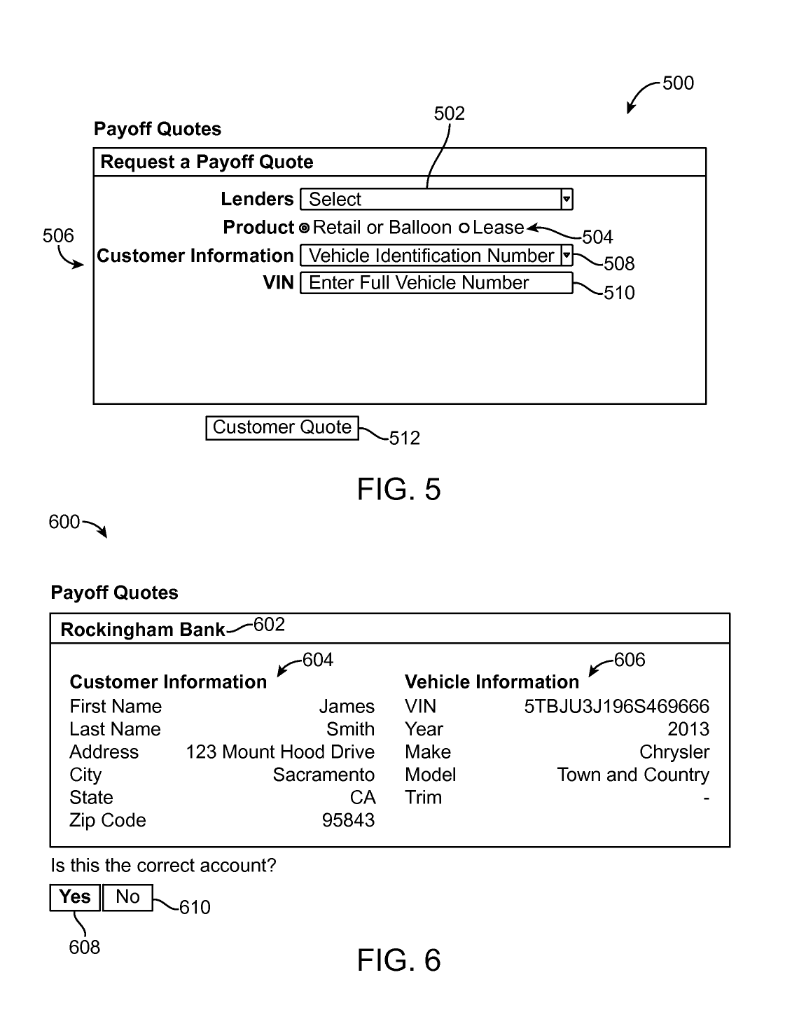

FIGS. 5-10 illustrate exemplary embodiments of quote and status UIs 210 (FIG. 2) that system 100 (FIG. 1) may utilize for implementing aspects of the present disclosure. FIG. 5 illustrates an example of request quote UI 500 that may be used, for example, at step 302 (FIG. 3) to obtain loan identification information from a user. As shown in FIG. 5, UI 500 may include a lender selector 502, such as a dropdown selector, for a user to select the lender associated with an outstanding loan on a vehicle trade-in. UI 500 may also include radio buttons 504 or other selector(s) for selecting product type, and a customer information region 506 for entering customer identifying information. In one example, product type may include selection of a loan or a lease, and such selection may invoke separate software modules configured to obtain appropriate data from a lender and perform the appropriate calculations to determine an exact payoff amount. In the illustrated embodiment, customer information region 506 includes an information type selector 508, such as a dropdown selector, for allowing a user to select the type of customer information he or she would like to enter. In one example, the number of different types of information may be lender-specific such that the selections available in information type selector 508 may vary depending on the lender selected in lender selector 502. In one example, information type selector 508 may include one or more of VIN, the customer's bank account number associated with the loan, a customer's name, and/or all or a portion of the customer's social security number. Customer information region 506 may also include user input field 510 for entering the customer information corresponding to the selected type. In the illustrated example, the user has selected “Vehicle Identification Number” as the information type in information type selector 508 and may enter the actual VIN number in input field 510. After selecting a lender and entering customer information, a user may select a customer quote button 512 for generating a payoff quote. Thus, UI 500 may provide some flexibility in terms of information required to generate a payoff quote depending on the information a potential purchaser provides a dealer.

FIG. 6 illustrates an exemplary account verification UI 600 that may be used, for example, at steps 304 and 306 (FIG. 3) to verify system 100 (FIG. 1) has identified the correct loan. As shown, UI 600 includes a bank name region 602, a customer information region 604, and a vehicle information region 606. As described above, in one example, the information displayed in UI 600 may be obtained directly from a lender's system or may be obtained from lender database 114. A user may review the information displayed, and if it is consistent with the information received from a purchaser, e.g, the purchaser's driver's license and vehicle registration, the user may select a “Yes” button 608 or the like to confirm system 100 has identified the correct account, and if not, the user may select a “No” button 610 or the like and the system may return to UI 500 for the user to confirm he or she has entered the correct information. If the user has selected “Yes” button 608, system 100 may execute a series of steps, including, for example, steps 308 and subroutine 311 (FIG. 3) and then generate a payoff quote UI, such as payoff quote UI 700 of FIG. 7.

As shown in FIG. 7, in this example payoff quote UI 700 provides a user with a comprehensive set of information needed to negotiate a new deal involving a trade-in with an outstanding loan and for initiating an accelerated payoff and title transfer process. Payoff quote UI 700 may include a bank information region 702, a title status region 704, a title information region 706, a payment information region 708, a customer information region 710, a user information region 712, a document upload selector 714, a payoff button 716, and a save button 718. Title status region 704 may provide a quick view of whether the vehicle title is releasable. In one embodiment, if the title is not releasable, or if it is encumbered by more than one lien, payoff button 716 will not be displayed or otherwise activated. A user may select, for example, a “View Title Image” hyperlink 720 to display a scanned image of the physical title, and the user may evaluate the lien and owner information on the title image and compare that information to customer information 710 and information provided by the potential purchaser, such as the purchaser's driver's license and vehicle registration. A dealership-user can, therefore, substantially instantly obtain a comprehensive snapshot of vehicle title information before entering into a negotiation process with a purchaser or seeking financing for a new deal. A user can also review payment information region 708, including the exact payoff amount required to pay off the loan, which may be calculated by subroutine 311 (FIG. 3) using, e.g., process 400 (FIG. 4). If the user is not ready to initiate the payoff process, he may select save button 718 for saving the quote for future use. For example, after confirming ownership, title status, and exact payoff amount, a title requestor may save the quote and finalize a negotiation with a purchaser, obtain any financing required to complete the new deal, or otherwise complete preliminary steps before initiating payoff. In some embodiments, user security settings may be implemented such that only certain users have permissions to initiate a payoff process. In such cases, payoff button 716 may be grayed out, or otherwise not selectable for users without sufficient permissions. When ready to initiate payoff and title transfer, a user may select payoff button 716 to initiate the process. UI 700 may also include user information fields 712 for selecting a specific title requestor location for mailing the title and document upload selector 714 for uploading any documents required to complete the payoff and title transfer process, such as, for example, an Authorization of Payoff indicating the consumer consents to the title requestor paying off the loan on behalf of the consumer.

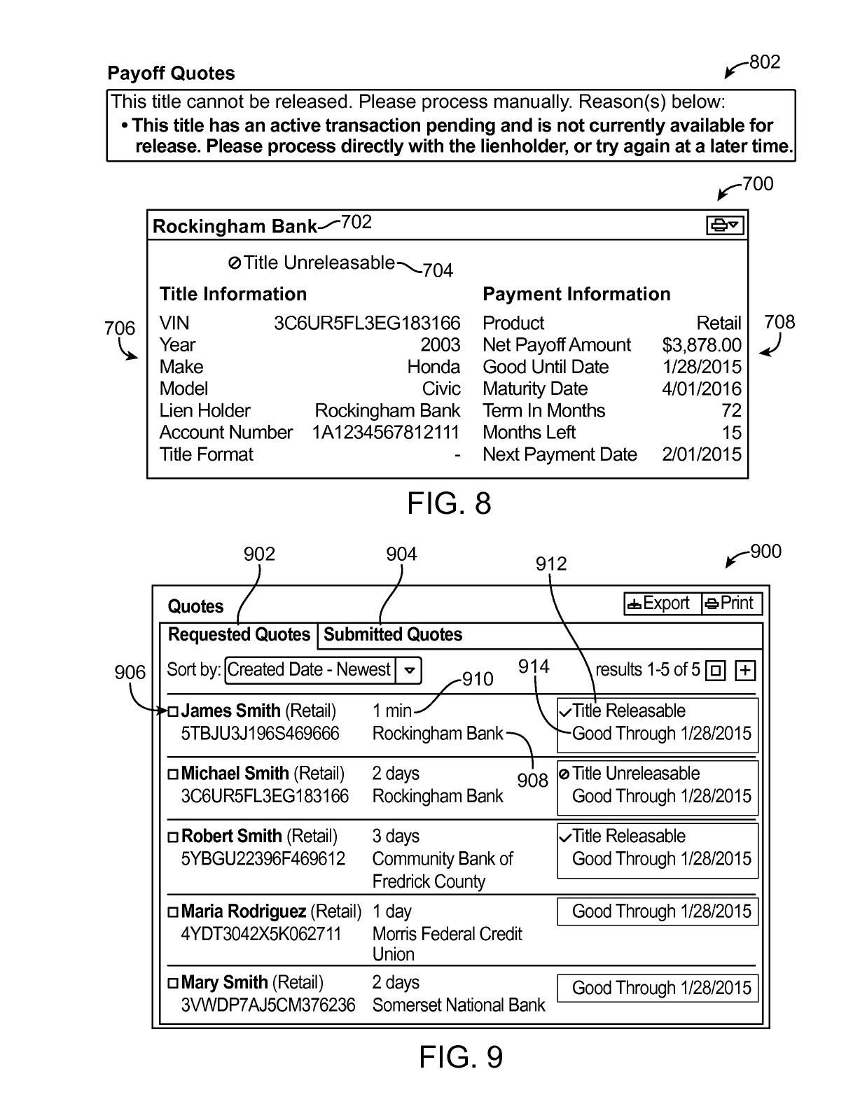

FIG. 8 illustrates another example of quote payoff UI 700 when it is displaying a payoff quote and title status for a vehicle that does not have a title that is releasable. As shown in FIG. 8, title status region 704 provides an indication that the title is not releasable for some reason, and UI 700 also includes a message region 802 containing an explanation of why the title is not releasable and providing further information on the user's options.

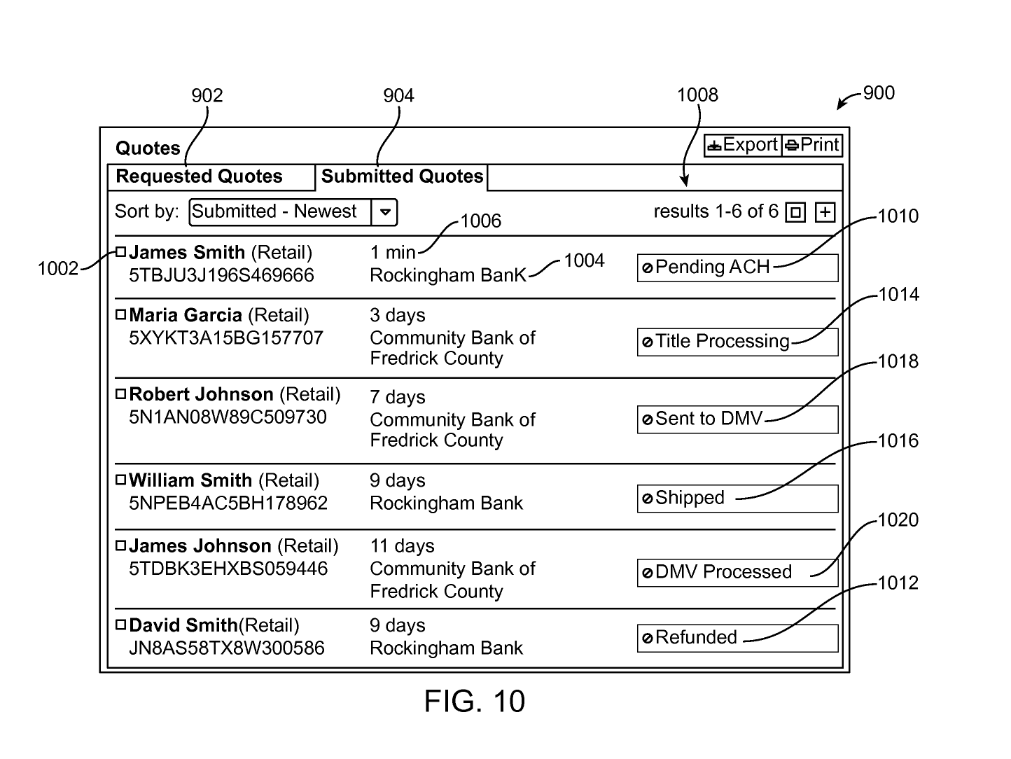

FIGS. 9 and 10 illustrate an example of a quote summary UI 900 that includes a requested quotes tab 902 that lists the quotes the user has previously requested and saved and a submitted quotes tab 904 for reviewing the status of quotes the user has initiated the payoff and title transfer process for. As shown in FIG. 9, requested quotes tab 902 provides a listing of previously-generated quotes, with each row including identification information 906, lender information 908, a time 910 since the quote was saved, a title status 912, and a good through date 914 representing the date the payoff calculation assumed the lender would receive the payoff amount. In one embodiment, system 100 may automatically update title status 912 when a user logs on to the system, so that a user can quickly view current status in requested quotes UI 902 to see when a title becomes releasable so the payoff and transfer process may begin. A user may select one of the saved quotes displayed via requested quotes UI tab 902 to display quote UI 700 for the specific trade-in.

FIG. 10 illustrates quote summary UI 900 after user selection of submitted quotes tab 904. As shown, submitted quotes tab 904 may cause system 100 to provide a real-time status of each trade-in for which a user has initiated the payoff and title transfer process with the system. As shown, submitted quotes tab UI 904 may include a listing of submitted quotes. The two left-most columns of submitted quotes UI may include similar kinds of information as the two left-most columns of quote summary UI 900 when a user has selected requested quotes tab 902—identification information 1002, lender information 1004, and time since the payoff process was initiated 1006 by, e.g., selecting payoff button 716 (FIG. 7). Quote summary UI 900 also includes a status column 1008 that may include, for each quote record, a real-time status indicator so that a title requestor employee may quickly tell which stage of the process each request is currently at. For example, status indicators may include indications that the fund transfer is still pending (1010), that the fund transfer was not complete and the funds were refunded to the title requestor (1012), that the fund transfer is complete and title processing and release has begun (1014), or that the title has been processed and is en route to the title requestor (1016). For electronic titles held by a DMV, status indicators may include an indication that a title transfer request has been sent to a DMV (1018) and may also include an indication that the DMV has completed processing the title (1020). Thus, quote summary UI 900 under submitted quotes tab 904 can be a powerful and useful tool for allowing a user to quickly learn which of a plurality of pending title requests are proceeding smoothly, and which ones have issues that need to be addressed. A title requestor can also use requested quotes UI 902 to estimate when a title will arrive at a title requestor location.

Any one or more of the aspects and embodiments described herein may be conveniently implemented using one or more machines (e.g., one or more computing devices that are utilized as a network computing device, one or more server devices, such as a Web server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

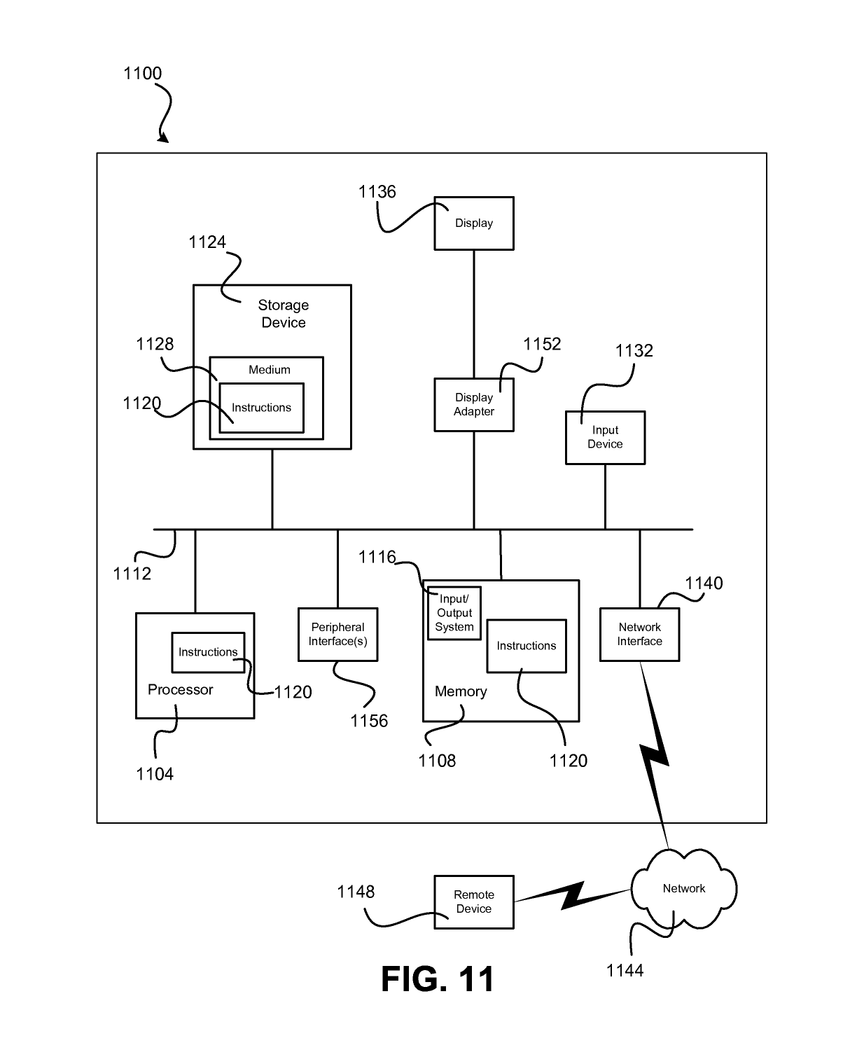

FIG. 11 shows a diagrammatic representation of one embodiment of a computing device in the exemplary form of a computer system 1100 within which a set of instructions for causing a system, such as system 100 of FIG. 1, to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1100 includes a processor 1104 and a memory 1108 that communicate with each other, and with other components, via a bus 1112. Bus 1112 may include any of several types of bus structures including, but not limited to, a memory bus, a memory controller, a peripheral bus, a local bus, and any combinations thereof, using any of a variety of bus architectures.

Memory 1108 may include various components (e.g., machine-readable media) including, but not limited to, a random access memory component, a read only component, and any combinations thereof. In one example, a basic input/output system 1116 (BIOS), including basic routines that help to transfer information between elements within computer system 1100, such as during start-up, may be stored in memory 1108. Memory 1108 may also include (e.g., stored on one or more machine-readable media) instructions (e.g., software) 1120 embodying any one or more of the aspects and/or methodologies of the present disclosure. In another example, memory 1108 may further include any number of program modules including, but not limited to, an operating system, one or more application programs, other program modules, program data, and any combinations thereof.

Computer system 1100 may also include a storage device 1124. Examples of a storage device (e.g., storage device 1124) include, but are not limited to, a hard disk drive, a magnetic disk drive, an optical disc drive in combination with an optical medium, a solid-state memory device, and any combinations thereof. Storage device 1124 may be connected to bus 1112 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1124 (or one or more components thereof) may be removably interfaced with computer system 1100 (e.g., via an external port connector (not shown)). Particularly, storage device 1124 and an associated machine-readable medium 1128 may provide nonvolatile and/or volatile storage of machine-readable instructions, data structures, program modules, and/or other data for computer system 1100. In one example, software 1120 may reside, completely or partially, within machine-readable medium 1128. In another example, software 1120 may reside, completely or partially, within processor 1104.

Computer system 1100 may also include an input device 1132. In one example, a user of computer system 1100 may enter commands and/or other information into computer system 1100 via input device 1132. Examples of an input device 1132 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1132 may be interfaced to bus 1112 via any of a variety of interfaces (not shown) including, but not limited to, a serial interface, a parallel interface, a game port, a USB interface, a FIREWIRE interface, a direct interface to bus 1112, and any combinations thereof. Input device 1132 may include a touch screen interface that may be a part of or separate from display 1136, discussed further below. Input device 1132 may be utilized as a user selection device for selecting one or more graphical representations in a graphical interface as described above.

A user may also input commands and/or other information to computer system 1100 via storage device 1124 (e.g., a removable disk drive, a flash drive, etc.) and/or network interface device 1140. A network interface device, such as network interface device 1140, may be utilized for connecting computer system 1100 to one or more of a variety of networks, such as network 1144, and one or more remote devices 1148 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1144, may employ a wired and/or a wireless mode of communication. In general, any network topology may be used. Information (e.g., data, software 1120, etc.) may be communicated to and/or from computer system 1100 via network interface device 1140.

Computer system 1100 may further include a video display adapter 1152 for communicating a displayable image to a display device, such as display device 1136. Examples of a display device include, but are not limited to, a liquid crystal display (LCD), a cathode ray tube (CRT), a plasma display, a light emitting diode (LED) display, and any combinations thereof. Display adapter 1152 and display device 1136 may be utilized in combination with processor 1104 to provide graphical representations of aspects of the present disclosure. In addition to a display device, computer system 1100 may include one or more other peripheral output devices including, but not limited to, an audio speaker, a printer, and any combinations thereof. Such peripheral output devices may be connected to bus 1112 via a peripheral interface 1156. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A computer-implemented method for paying off a loan secured by a lien on a vehicle and transferring the vehicle's title to a title requestor, the computer-implemented method comprising:
receiving, at a loan payoff and title transfer server, a payoff quote request including lender and loan identification information;
accessing, with the loan payoff and title transfer server, loan and title information;
calculating, with the loan payoff and title transfer server, based on the loan information, an exact payoff amount for paying off the loan;
displaying, on a quote user interface (UI), the title information and the exact payoff amount;
receiving, via the quote UI, a user instruction to pay off the loan;
initiating, with the loan payoff and title transfer server, an electronic fund transfer of the exact payoff amount from a title requestor bank account to an intermediate bank account;
transferring, with the loan payoff and title transfer server, the exact payoff amount from the intermediate bank account to a lien-holder bank account; and
sending, with the loan payoff server, a title transfer instruction to a title manager to send the title to the title requestor.

2. A method according to claim 1, wherein said sending the title transfer instruction occurs at substantially the same time as said step of transferring the payoff amount to the lien-holder bank account.

3. A method according to claim 1, wherein said sending the title transfer instruction occurs before the lien-holder bank account receives the payoff amount.

4. A method according to claim 1, wherein said sending the title transfer instruction occurs prior to lien-holder review of the electronic fund transfer of the payoff amount.

5. A method according to claim 1, wherein said displaying the title information includes displaying whether the title is releasable and displaying an image of the title.

6. A method according to claim 5, wherein said displaying occurs substantially immediately after said receiving lender and loan identification information.

7. A method according to claim 6, wherein the only user input required to execute said displaying is providing (1) lender identification information and (2) customer identification information.

8. A method according to claim 7, wherein the customer identification information is a vehicle identification number.

9. A method according to claim 1, wherein said accessing includes accessing, with the loan payoff and title transfer server, the loan information from at least one of a lender database that stores loan information for a plurality of loans held by a plurality of lenders, and a direct connection to a computer system of a lender associated with the lender identification information.

10. A method according to claim 1, wherein said accessing includes accessing, with the loan payoff and title transfer server, the title information from a title database of a title manager, the title manager having a title vault for storing a plurality of physical vehicle titles encumbered by liens held by a plurality of lien-holders.

11. A method according to claim 1, wherein the vehicle title is an electronic title held by a Department of Motor Vehicles (DMV), said accessing including accessing, with the loan payoff and title transfer server, the title information from the DMV.

12. A method according to claim 1, wherein:
said calculating includes determining, based on a specific electronic fund transfer method, an exact date the lien-holder bank account will receive the exact payoff amount, determining a payoff amount for the loan on the exact date, and setting the exact payoff amount equal to the determined payoff amount; and
said transferring includes transferring the exact payoff amount using the specific electronic fund transfer method.

13. A title transfer portal for providing automated payoff of loans secured by liens on vehicle titles held by a plurality of lenders, the title transfer portal comprising:
at least one loan payoff and title transfer server having a memory containing machine-executable instructions for providing:
a request quote user interface (UI) designed and configured to solicit and receive from a user lender information and loan information associated with a vehicle having a title; and
a payoff quote user interface designed and configured to display to the user, substantially immediately after receiving the lender and loan information:
a title status indicating whether or not the title is releasable;
an image of the title;
an exact payoff amount calculated by the at least one loan payoff and title transfer server based on a predetermined electronic fund transfer process; and
a payoff button selectable by the user to initiate a fund transfer for the payoff amount using the predetermined electronic fund transfer process.

14. A title transfer portal according to claim 13, wherein said payoff button is not activated when said title status indicates the title is not releasable.

15. A title transfer portal according to claim 13, wherein said machine-executable instructions further include instructions for a requested quotes UI designed and configured to display a list of vehicles for which a quote request was received by said request quote UI but a fund transfer request was not initiated, said list including a current title status field for indicating a vehicle's title is currently releasable.

16. A title transfer portal according to claim 13, wherein said machine-executable instructions further include instructions for a submitted quotes UI configured to display a list of vehicles for which a fund transfer request has been initiated, said list including a current status field for each vehicle that provides a current status of the fund transfer and a current status of a title transfer.

17. A title transfer portal according to claim 13, wherein said machine-executable instructions further include instructions designed and configured to cause said at least one loan payoff server to:
in response to a user instruction to initiate a fund transfer, send a fund transfer instruction to a fund transfer service to withdraw said exact payoff amount from a bank account associated with the user and transfer the exact payoff amount to an intermediate account;
verify said intermediate account has received said exact payoff amount and a required waiting period has lapsed; and
after said verify step, perform the steps of:
sending a title transfer instruction to a title manager to transfer the title to the user; and
transferring said exact payoff amount from said intermediate account to a lender account;
wherein said payoff and title transfer module is configured to execute said sending and transferring steps at substantially the same time.

18. A loan payoff and title transfer system, comprising:
a title manager including a title vault and at least one title manager server, said title vault containing a plurality of vehicle titles of vehicles encumbered by liens held by a plurality of lenders; and
at least one loan payoff and title transfer server operably connected to said at least one title manager server, said at least one loan payoff and title transfer having or operably connected to a memory containing machine-executable instructions for:
receiving a payoff quote request from a title requestor for a loan held by one of the plurality of lenders that is secured by a lien on a vehicle associated with one of said plurality of vehicle titles stored in said title vault, the payoff request including lender and loan identification information;
accessing loan information associated with the loan;
requesting, from said title manager server, title information associated with the vehicle title encumbered by the lien;
calculating, based on the loan information, an exact payoff amount for paying off the loan; and
displaying, on a quote user interface (UI), the title information and the exact payoff amount.

19. A loan payoff and title transfer system according to claim 18, wherein said machine-executable instructions further include instructions for:
receiving, via the quote UI, a user instruction to pay off the loan;
initiating an electronic fund transfer of the payoff amount from a first bank account to an intermediate bank account;
transferring the payoff amount from the intermediate bank account to the lender holding the loan; and
sending a title transfer instruction to the title manager server to send the title to the title requestor.

20. A loan payoff and title transfer system according to claim 19, wherein said machine-executable instructions further include instructions for executing said transferring and sending steps at substantially the same time.

21. A loan payoff and title transfer system according to claim 18, wherein said title manager further includes a title database for storing information associated with the plurality of vehicle titles, said requesting includes requesting access to a scanned image of the vehicle title stored in said title database, and said displaying the title information includes displaying a title image field for viewing the scanned image.
